(19) United States
(12) Patent Application Publication
(10) Pub. No.: US 2004/0042053 A1
(43) Pub. Date: Mar. 4, 2004

(54) Film scanner

(75) Inventor: Shuzo Seo, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/645,622

(22) Filed: Aug. 22, 2003

(30) Foreign Application Priority Data
Aug. 28, 2002 (JP) 2002-248752

(51) Int. Cl. H04N 1/04

(52) U.S. Cl. 358/475; 358/487

(57) ABSTRACT

A film scanner includes a light source, an illumination optical system which illuminates a film surface of a film with a light bundle emitted from the light source after the light bundle is varied in accordance with a film size of the film, and an image pickup optical system which makes the light bundle transmitted through the film surface incident upon an image pickup element after the light bundle is varied in accordance with the size of an effective area of the image pickup element.

### BACKGROUND OF THE INVENTION

1. Field of the Invention

The present invention relates to a film scanner in which an image recorded on an exposed silver halide film is picked up and converted into digital image data.

2. Description of the Related Art

In general, a film scanner in which an image recorded on an exposed silver halide film is scanned to produce digital image data includes a light source, an image pickup element, an illuminating optical system which transmits light emitted from the light source to a film, and an image pickup optical system which transmits the light transmitted through the film to the image pickup element.

In many film scanners, films of different sizes (i.e., different widths of film strip), such as a 35 mm film or a Brownie film (a strip of film having a width of 60 mm), can be scanned. However, in conventional film scanners, the illumination optical system and image pickup optical system are provided so that the image on the film having the largest width matches with the area of the image pickup element.

To solve this problem, the image pickup optical system can be constructed as a optical system in which the focal length can be switched, so that the image pickup element does not have a non-utilized area when a narrow film is scanned. However, if the image pickup optical system is constructed from a optical system in which the focal length can be switched, the amount of light which can be received by the image pickup element is remarkably reduced when the small width film is scanned, thus resulting in a dark image compared to when a large width film is scanned.

Moreover, in conventional film scanners, a fluorescent lamp is used as the light source. Accordingly, it is difficult to synchronize the picking up of the image by the image pickup element with the emission of light by the fluorescent lamp. If synchronization fails, the picking-up of image is carried out with an insufficient amount of light. Furthermore, there is a drawback that the fluorescent lamp has large power consumption.

### SUMMARY OF THE INVENTION

The present invention provides a film scanner in which an image pickup optical system has a zooming function to make it possible to pick up images of films of different sizes at the same size, and the amount of light which can be received by the image pickup element is not reduced if the zooming operation of the image pickup optical system is carried out.

According to an aspect of the present invention, a film scanner is provided, including a light source, an illumination optical system which illuminates a film surface of a film with a light bundle emitted from the light source after the light bundle is varied in accordance with a film size of the film, and an image pickup optical system which makes the light bundle transmitted through the film surface incident upon an image pickup element after the light bundle is varied in accordance with the size of an effective area of the image pickup element.

It is desirable for the image pickup optical system to have a plurality of image pickup optical systems having different focal lengths, the plurality of image pickup optical system being selectively used.

It is desirable for the film scanner to include an image pickup optical system selection mechanism for selecting the plurality of image pickup optical systems, a power varying mechanism for varying the optical power of the illumination optical system, and a single drive mechanism for driving the image pickup optical system selection mechanism and the power varying mechanism.

The light source can be an LED.

The present disclosure relates to subject matter contained in Japanese Patent Application No. 2002-248752 (filed on Aug. 28, 2002) which is expressly incorporated herein by reference in its entirety.

### BRIEF DESCRIPTION OF THE DRAWINGS

The invention will be discussed below with reference to the accompanying drawings, in which;

FIG. 1 is a longitudinal sectional view of a film scanner which scans a Brownie film, according to an embodiment of the present invention;

FIG. 2 is a plan view of an internal structure of the film scanner when a Brownie film is scanned;

FIG. 3 is a plan view of an image pickup optical system when a Brownie film is scanned;

FIG. 4 is a sectional view of a drive mechanism of the image pickup optical system and an illumination optical system;

FIG. 5 is a side elevational view of main components of the film scanner which scans a 35 mm film; and

FIG. 6 is a plan view of an internal structure of the film scanner when a 35 mm film is scanned.

### DESCRIPTION OF THE PREFERRED EMBODIMENT

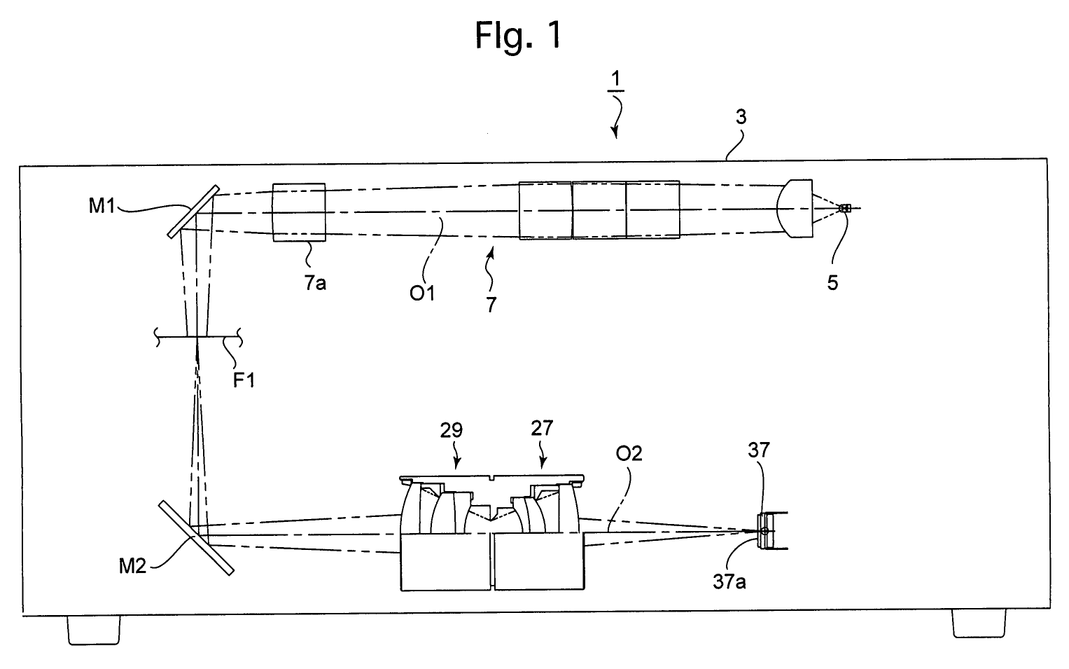

An embodiment of the present invention will be discussed with reference to the drawings. As shown in FIG. 1, a film scanner 1 includes a casing 3 in the form of a laterally extending rectangular parallelepiped in which a light source made of a white LED 5, an illumination optical system 7, a pair of upper and lower mirrors M1, M2, an image pickup optical system 27, an RGB 3-line linear CCD (image pickup element) 37 which will be referred to hereinafter as a linear CCD, a drive mechanism of the illumination optical system 7 and the image pickup optical system 27, and a motor M as a drive source of the drive mechanism are arranged. The rotating shaft 15, the gear 17, the rotation transmission shaft 19, the gears 21, 23, the gear 25, the upper gear train G1, the lower gear train G2, the motor M, and the pinion P thereof constitute the drive mechanism.

The casing 3 is provided, on the front surface thereof, with a film insertion opening (not shown) and a slot (not shown) for a memory card. In the vicinity of the film insertion opening and the memory card slot, ejector buttons (not shown) are provided to eject a film F1 or F2 and a memory card (not shown), inserted in the film insertion opening and the memory card slot, respectively. A Brownie film F1 and a 35 mm film F2 can be selectively inserted in the film insertion opening. In the casing 3, a film discrimination sensor (not shown) which discriminates the films F1 and F2, and a film feeder (not shown) which moves the film F1 or F2 in the right hand direction in FIG. 1 intermittently by a displacement corresponding to a line pitch of the linear CCD 37 are arranged. The film discrimination sensor and the film feeder are connected to a CPU (not shown).

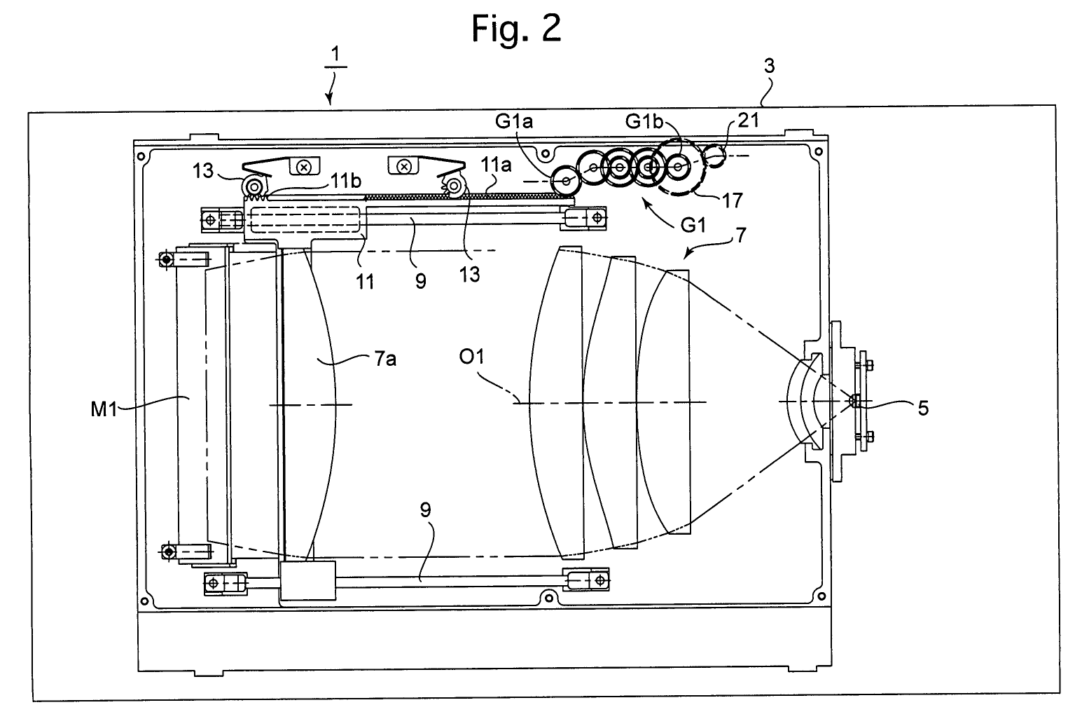

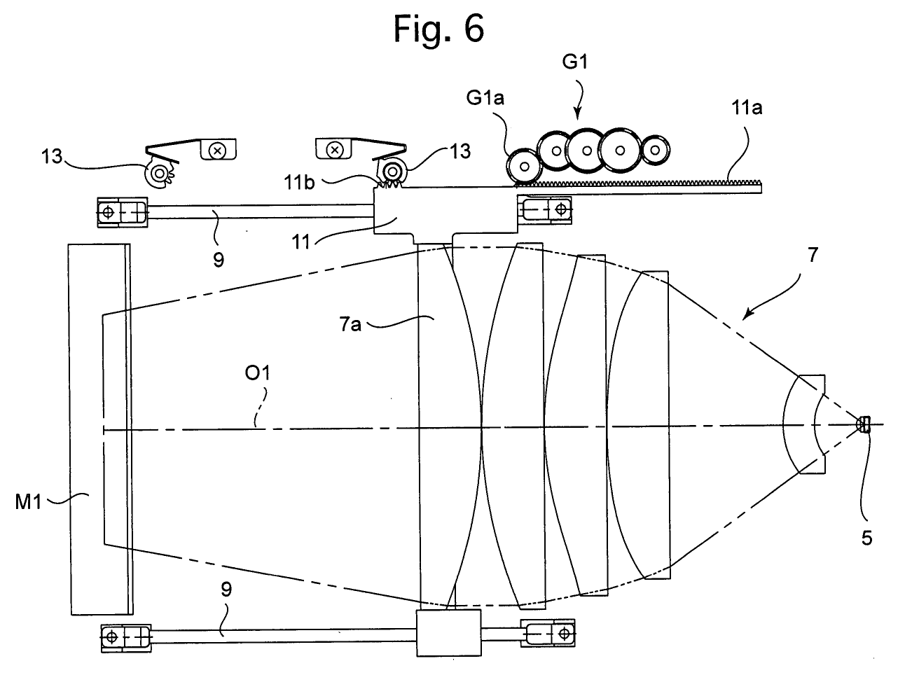

The white LED 5 is located in the casing 3 at the upper corner thereof and emits light from the front surface of the LED. The illumination optical system 7 which receives the light emitted from the white LED 5 is made of a plurality of lenses. As can be seen in FIGS. 2 and 6, a pair of guide rails 9 are provided on opposite sides of the illumination optical system 7 and extend in a direction parallel with the optical axis O1 of the illumination optical system 7. A lens holder 11 is slidably fitted in the guide rails 9. The lens holder 11 holds a movable lens 7a of the illumination optical system 7. The illumination optical system 7 includes a plurality of lenses of which only the lens 7a is movable in the optical axis direction O1 and the remaining lenses are all stationary.

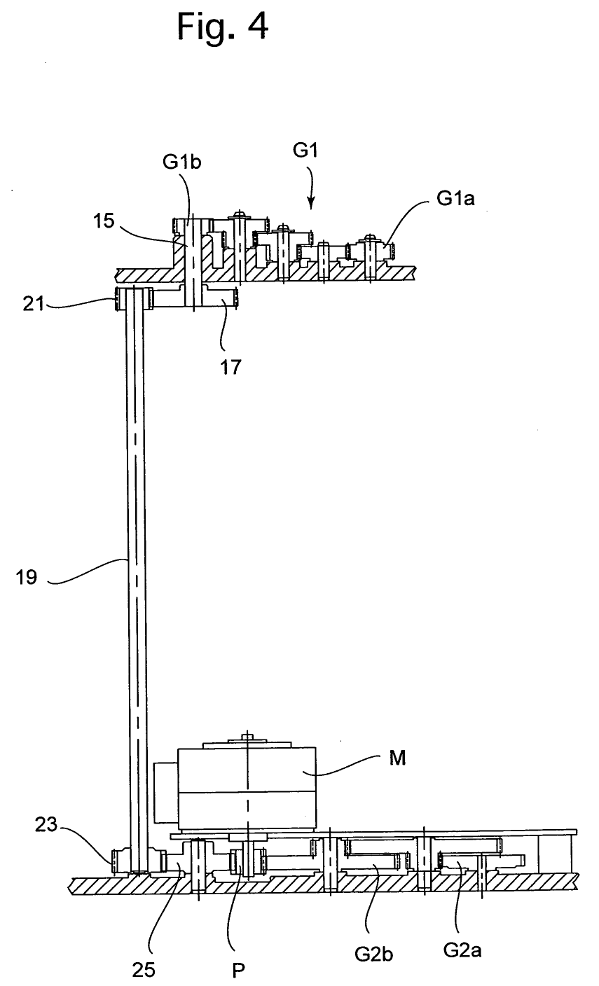

The lens holder 11 is provided on the side surface thereof with long and short racks 11a and 11b (power varying mechanism) which extend in the optical axis direction. The long rack 11a is always engaged with a gear G1a which is located at one end of an upper gear train G1 and is disengageably engaged with one of gears 13 that is located adjacent to the upper gear train G1. The short rack 11b is disengageably engaged with both the gears 13. As shown in FIG. 4, a gear G1b at the other end of the upper gear train G1 has a rotating shaft 15 to which a gear 17 is secured at the lower end of the shaft. The gear 17 engages with a gear 21 secured to an upper end of a rotation transmission shaft 19 which extends in the upward and downward direction. A gear 23 which is secured to the lower end of the rotation transmission shaft 19 is in mesh with a gear 25 which is in mesh with a pinion P secured to the drive shaft of the motor M. The motor M is connected to the CPU so that the motor M rotates in the forward or reverse direction in accordance with a forward or reverse rotation signal supplied from the CPU. The rotational force is transmitted to the long rack 11a through the gears 25, 23, 21, 17 and the upper gear train G1, so that the lens holder 11 (lens 7a) is moved in the optical axis direction O1 to vary the focal length of the illumination optical system 7.

The mirror M1 is provided on the side of the illumination optical system 7 away from the white LED 5. The second mirror M2 is provided directly below the first mirror M1.

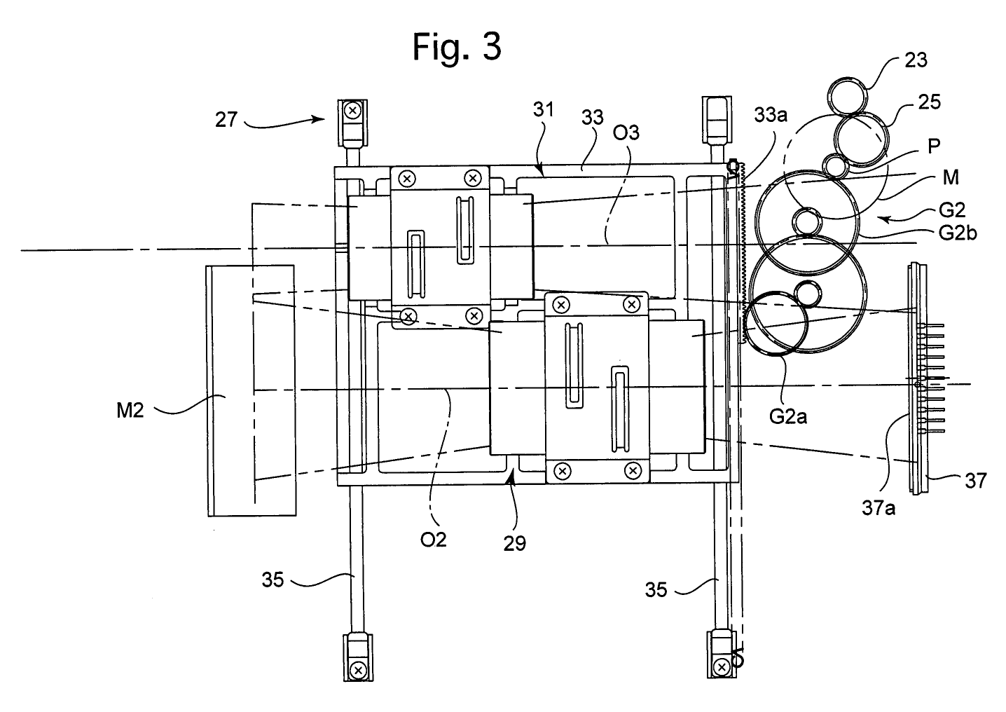

The image pickup optical system 27 is arranged on the right side of the lower mirror M2 in FIG. 1. The image pickup optical system 27 includes two image pickup optical systems (a first image pickup optical system 29 and a second image pickup optical system 31) having different focal lengths, as shown in FIG. 3. The image pickup optical systems 29 and 31 have optical axes O2 and O3 extending in parallel with the optical axis O1. The first and second image pickup optical systems 29 and 31 are held by an image pickup optical system holder 33 which is, in turn, slidably held by a pair of guide rails 35 perpendicular to the optical axes O2 and O3. The image pickup optical system holder 33 is provided with a rack (image pickup optical system selection mechanism) 33a which is always in mesh with a gear G2a located at one end of a lower gear train G2. As shown in FIG. 4, a gear G2b at the other end of the lower gear train G2 is in mesh with the pinion P of the motor M, so that when the motor M is rotated in the forward or reverse direction, the rotational force of the motor M is transmitted to the rack 33a through the gear train G2. Consequently, the first image pickup optical system 29 or the second image pickup optical system 31 is moved between the mirror m2 and the linear CCD 37.

The scanning operation of the film F1 or F2, using the film scanner constructed as above will be discussed below.

A power switch (not shown) is turned ON to cause the white LED 5 to emit light and a memory card is inserted in the memory card slot. Thereafter, the Brownie film F1 is inserted in the film insertion opening of the casing 3. The film discrimination sensor detects that the inserted film is the Brownie film F1. As a result, the motor M is rotated in the forward direction in response to the forward rotation signal supplied from the CPU to the motor M. The rotation of the motor M is transmitted to the lens holder 11 and the image pickup optical system 33 via the upper gear train G1 and the lower gear train G2, etc. Consequently, the lens holder 11 is moved close to the mirror M1 and the first image pickup optical system 29 is moved to a light path between the mirror M2 and the linear CCD 37, as shown in FIGS. 1 through 3. Moreover, an operation signal is supplied from the CPU to the film feeder, so that the brownie film F1 is moved between the upper and lower mirrors M1 and M2, intermittently by a displacement corresponding to the line pitch of the linear CCD 37.

In this position, as shown in FIG. 1, the light transmitted through the illumination optical system 7 is incident upon the mirror M1 and is reflected thereby downwardly. The reflected light is transmitted through one frame of the Brownie film F1 at a width corresponding to the line pitch, with a coverage slightly larger than the distance between the opposing sides of a photosensitive surface of the Brownie film F1. The light transmitted through the Brownie film F1 is reflected by the mirror M2 and is made incident upon the linear CCD 37 via the first image pickup optical system 29. Consequently, an image whose width corresponds to the line pitch, recorded on the photosensitive surface of the Brownie film F1 is formed on the entire light receiving surface 37a of the linear CCD 37. Thus, each frame is scanned at a width interval corresponding to the line pitch. The film is moved intermittently by a displacement corresponding to the line pitch by the film feeder, so that one frame can be entirely scanned. Thereafter, a subsequent frame is scanned.

The object image formed on the light receiving surface 37a is converted into electrical image data by the linear CCD 37. The image data is recorded in an internal memory through a gain control circuit, an A/D converter, a DSP, a memory controller, and the CPU. The CPU is connected to a card controller, so that the image data is recorded also in the memory card inserted in the memory card slot.

The digital image data processed in the film scanner 1 is converted into analogue data by a D/A converter, so that the analogue image data can be supplied to an external electronic device through a video output terminal.

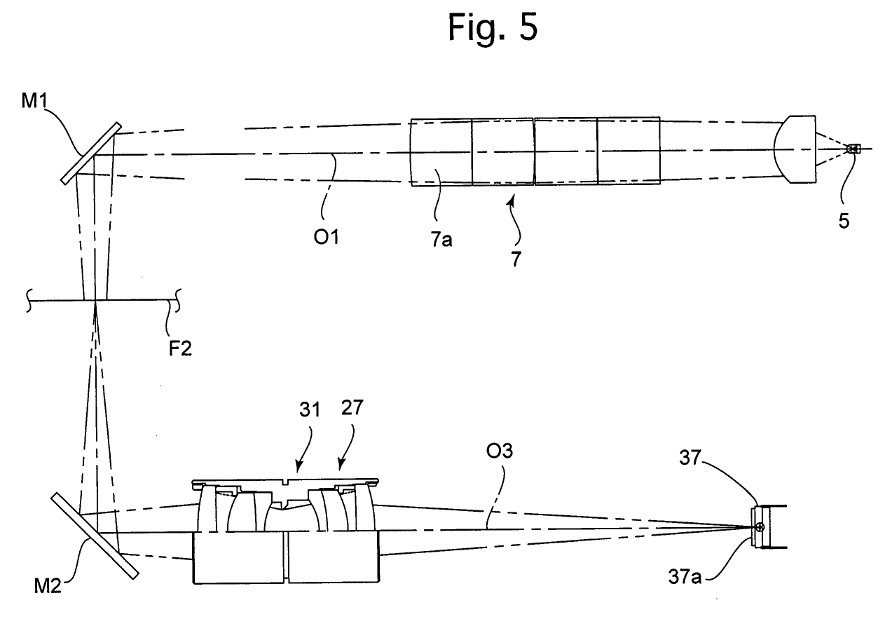

When a 35 mm film F2 is inserted in the film insertion opening, as shown in FIGS. 5 and 6, the film discrimination sensor detects that the inserted film is the 35 mm film F2. Consequently, the CPU sends a reverse rotation signal to the motor M, so that the motor M is rotated in the reverse direction. As a result, the lens holder 11 is moved away from the mirror M1, the second image pickup optical system 31 is moved in a light path between the mirror M2 and the linear CCD 37 while the first image pickup optical system 29 is moved out of the light path.

In this position, as shown in FIG. 6, the light transmitted through the illumination optical system 7 is incident upon the mirror M1, wherein the light incident upon the mirror M1 has a width smaller than that in FIG. 2. The light reflected downward by the mirror M1 is transmitted through the 35 mm film F2 at a width corresponding to the line pitch, with a coverage slightly larger than the distance between the opposing sides of a photosensitive surface of the 35 mm film F2. The light transmitted through the 35 mm film F2 is reflected by the mirror M2 and is made incident upon the linear CCD 37 via the second image pickup optical system 31. Consequently, an image of a portion corresponding to the line pitch of the 35 mm film F2 is formed on the entire light receiving surface 37a of the linear CCD 37. The object image formed on the light receiving surface 37a is converted into electrical image data which is recorded in an internal memory and the memory card, and can be transmitted to an external electronic device connected to the video output terminal or a personal computer through a digital interface.

As can be understood from the foregoing, according to the embodiment of the present invention, the light can be received by the entirety of the light receiving surface 37a of the linear CCD 37 by selectively using one of the two image pickup optical systems 27 (first image pickup optical system 29 and the second image pickup optical system 31) regardless of the kind of film to be used, i.e., the Brownie film F1 or the 35 mm film F2. Thus, the linear CCD 37 does not have a non-utilized area. Moreover, the light emitted from the white LED 5 can be transmitted through the film F1 or F2 with a coverage slightly larger than the distance between the opposing sides of the photosensitive surface of the film F1 or F2 by varying the power of the illumination optical system 7 depending on the kind of film, i.e., the film F1 or the film F2. Therefore, when the 35 mm film is scanned, the amount of light which can be received by the linear CCD 37 is not reduced, so that a bright image can be obtained.

Furthermore, since the white LED 5 is used as the light source, it is not necessary to synchronize the timing of the image pickup with the timing of the light emission of the light source, unlike the prior art in which the fluorescent lamp is used. Thus, the image can be always picked up by the linear CCD 37 with a sufficient amount of light.

In addition, since the white LED 5 consumes less amount of electric power, the cost can be reduced. Note that a light source other than the white LED 5 can be used, for example, an RGB LED.

Since the illumination optical system 7 and the image pickup optical system 27 are driven by the single drive mechanism having a single drive source (motor M), the drive mechanism can be simplified.

According to the present invention, even if the operation, in which the focal length can be switched, of the image pickup optical system is carried out, a bright image can be obtained without reducing the amount of light which can be received by the image pickup element.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A film scanner comprising:
a light source;
an illumination optical system configured to illuminate a film surface of a film with a light bundle emitted from the light source, after the light bundle is varied in accordance with a film size of the film; and
an image pickup optical system configured to make the light bundle transmitted through the film surface incident upon an image pickup element after the light bundle is varied in accordance with the size of an effective area of the image pickup element.

2. The film scanner according to claim 1, wherein said image pickup optical system includes a plurality of image pickup optical systems having different focal lengths, said plurality of image pickup optical systems configured to be selectively used.

3. The film scanner according to claim 2, further comprising:
an image pickup optical system selection mechanism configured to select a said image pickup optical system from said plurality of image pickup optical systems;
a power varying mechanism configured to vary the optical power of the illumination optical system; and
a single drive mechanism configured to drive the image pickup optical system selection mechanism and the power varying mechanism.

4. The film scanner according to claim 1, wherein the light source includes an LED.
